(19) United States
(12) Patent Application Publication
(10) Pub. No.: US 2005/0103778 A1
(43) Pub. Date: May 19, 2005

(54) Microwave desorder

(76) Inventors: Arthur A. Aykanian, Laguna Hills, CA (US); Steve Billingsley, Idaho Falls, ID (US); Philip M. Hodge, San Clemente, CA (US); Kevin L. Simpson, Bakersfield, CA (US); John Spisak, LoneTree, CO (US); Jim Strahan, Ludington, MI (US)

Correspondence Address: Richard L Myers;Myers Dawes Andras & Sherman, Suite 1150, 19900 MacArthur Boulevard, Irvine, CA, 92612, US

(21) Appl. No.: 10/484,747

(22) PCT Filed: Jul. 18, 2002
(86) PCT No.: PCT/US02/22878

Related U.S. Application Data
(60) Provisional application No. 60/306,816, filed on Jul. 20, 2001.

(51) Int. Cl. H05B 6/70

(52) U.S. Cl. 219/690

(57) ABSTRACT

A microwave desorber is used to remove volatile organic compounds from resins in order to recycle the resins. The desorber includes a container adapted to receive the contaminated resin, and at least one waveguide adapted to introduce microwave energy into the contaminates in the container. A mechanism is provided for moving one of the container and the waveguide relative to the other container and the waveguide to facilitate uniform heating of the contaminants. At least one of the container and the waveguide can be moved, such as oscillated, radially or axially. The contaminated resins can be moved through a preferred radial zone of the container in order to optimize the microwave heating in accordance with the particular contaminates or resins.

### RELATED APPLICATIONS

This application claims priority from U.S. Provisional Patent Application No. 60/306,816, filed Jul. 20, 2001 and entitled “Microwave Desorber”.

### BACKGROUND OF THE INVENTION

1. Field of the Invention

This invention relates generally to methods and apparatus for drying materials, and more specifically to microwave apparatus for removing volatile organic compounds from resins.

2. Discussion of the Prior Art

Microwaves have been used for many years to remove substances from various materials. In many cases this has occurred in dryers where moisture has been removed from the material using microwave energy.

More recently, microwaves have been used to remove volatile organic compounds (VOCs) from resins onto which the VOCs have been adsorbed. In this context the microwave energy is very effective in selectively heating most VOCs. The resin will also heat up to some degree because it is not completely transparent to the microwave energy. With these two heat sources, the VOCs tend to volatilize thereby cleaning the resins for subsequent use, for example in a continuous process.

In some cases, a large container having a diameter such as 24 inches has been filled with the contaminated resins. A stationary waveguide has been positioned along the axis of the container and suitably aperatured to release the microwave energy radially outwardly into the resin. In theory, the VOCs are volatized and thereby removed from the resins. A vacuum pump can be used to draw the VOCs from the resin and out of the vessel in either a batch or continuous process for treating the resin. Unfortunately, it has been found that the heat distribution within the large container varies significantly producing both hot spots and cold spots throughout the container. At the hot spots, the VOCs are released from the resin, but at the cold spots, these released VOCs are merely adsorbed back onto the resins. As a result, a relatively low efficiency results requiring considerable time and energy to clean the resin batch. Processes in which the resin flows continuously through the desorber vessel, also suffer, but to a lesser degree, because of the time averaging effect of moving the resin through a certain temperature profile or distribution.

### SUMMARY OF THE INVENTION

In accordance with the present invention, the waveguide along the axis of the container is moved relative to the container. As a result, the microwave energy is more uniformly distributed throughout the container. This relative movement will generally result as the waveguide is moved axially back and forth within a stationary container. The waveguide may also be oscillated and/or rotated on the axis of the container to produce this relative movement. Of course the container could also be moved relative to a stationary waveguide to produce a heat pattern which is more uniformed.

It has been found that temperature distributions vary radially within a cylindrical cavity. This distribution can be experimentally or theoretically calculated and an optimal radial section can be chosen for a particular microwave load. By placing the resin within this zone or otherwise passing the resin through this zone, more uniform heat distribution will result in a much higher efficiency and require less time to clean the resins.

In one aspect, the invention relates to a system for removing contaminants adsorbed onto a resin. A container is provided to receive the contaminated resin. At least one waveguide having an axis is disposed within the container and adapted to introduce microwave energy into the contaminated resins in the container. A mechanism is provided for moving one of the container and the waveguide relative to the other of the container and the waveguide to facilitate uniform heating of the contaminated resin in the container. This relative movement can result from movement of one or both of the container and waveguide. The movement may be axial or radial and will typically be an oscillating movement.

In another aspect of the invention, the container has an outer wall, and the waveguide has an inner wall. At least one zone wall is disposed between the inner wall and the outer wall, and defines a preferred zone within the container where optimum heating characteristics occur for separating the contaminants from the resin. The zone wall can be formed from a low loss material having microwave transmission characteristics greater than that of a metal. A second zone wall can be disposed between the first zone wall and the outer wall of the container. In this case, the preferred zone is spaced from the inner wall of the waveguide and the outer wall of the container.

In an additional aspect, the invention includes a method for removing contaminants adsorbed onto a resin. This method includes the steps of providing a container to receive the contaminated resin, and positioning at least one waveguide within the container. Microwave energy is introduced through the waveguide into the contaminated resin to heat the contaminants. This method also includes the step of moving one of the container and the waveguide relative to the other of the container and the waveguide to facilitate heating of the contaminant during the heating step.

In a further aspect of the invention, a method for removing contaminants adsorbed onto a resin includes the step of defining a preferred zone in the container between the outer wall of the container and the inner wall of the waveguide. This preferred zone has optimal heating characteristics for heating the contaminant. After the contaminants have been heated to separate them from the resin, the contaminants can be removed from the preferred zone.

These and other features and advantages of the invention will become more apparent with a description of the preferred embodiments of the invention with reference with the associated drawings.

### DESCRIPTION OF THE DRAWINGS

FIG. 1 is an axial cross-section view of one embodiment of the present invention including a container and microwave waveguide, with contaminated resin positioned in an optimum zone to facilitate heating of the contaminants;

FIG. 2 is a cross-sectional view taken along lines 2-2 of FIG. 1 and illustrating a preferred relative disposition of inlet and outlet valves; and

FIG. 3 is a perspective view of the microwave waveguide illustrated in FIGS. 1 and 2.

### DESCRIPTION OF THE PREFERRED EMBODIMENTS AND BEST MODE OF THE INVENTION

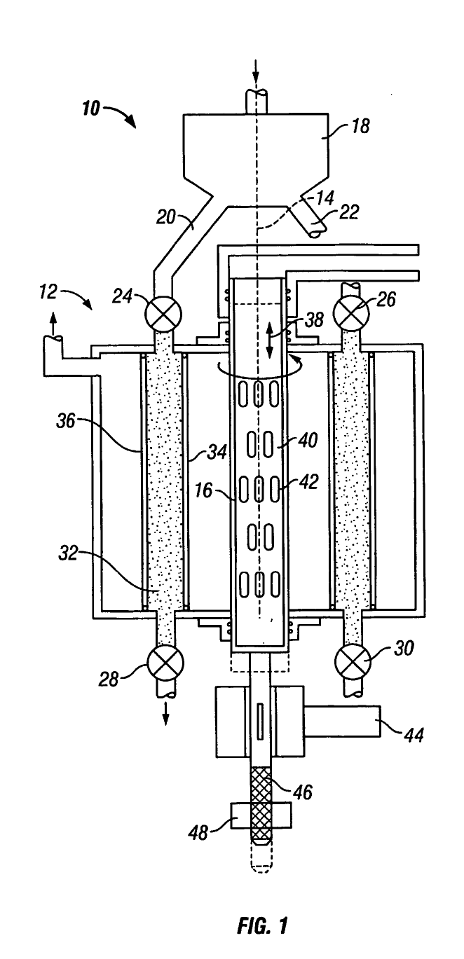

The system of the present invention is illustrated in FIG. 1 and designated by the reference numeral 10. This system includes a container 12 having an axis 14. A waveguide 16, which receives microwave energy from a generator (not shown), is disposed along the axis 14. A resin hold tank 18 receives contaminated resin from an adsorber (not shown) and introduces this load through two or more delivery lines such as those designated by reference numerals 20 and 22. These delivery lines 20 and 22 are connected through inlet valves 24 and 26 to introduce the contaminated resin into the container 12. Similar outlet valves 28 and 30 are provided at the output of the container 12 to direct the clean resin back to the adsorber (not shown). Between the inlet valves 24 and 26, and the outlet valves 28, 30, the contaminated resin is exposed to microwave energy within the container 12 which drives off the VOCs. Vacuum is applied to the vessel to extract these volatilized gases. A radial flow of nitrogen or other inert purge gas can be used in conjunction with the vacuum.

In the interest of obtaining a more even distribution of heat within the container 12, a particular radial zone 32 is chosen where the heat is most evenly distributed. This zone 32 will typically exist between two concentric cylinders which provide the zone 32 with a cylindrical configuration. These cylinders are preferably formed from low loss materials, such as ceramics and fiberglass, which are generally transparent to microwave radiation. These materials permit more of the microwaves to heat the VOCs first from the direct application of energy from the waveguide 16, and second from the energy reflected back from the walls of the container 12.

In this embodiment, the inner cylinder defining the zone 32 will typically have a wall 34 with a diameter D1 typically greater than the diameter of the waveguide 16. The outer cylinder defining the zone 32 will have a wall 36 with a diameter D2 typically less than that of the container 12. The diameter D1 will be less than the diameter D2. For example, in a preferred embodiment, the waveguide 16 may have a diameter of four inches while the container 12 has a diameter of 24 inches. The inside diameter D1 of the zone 32 is twelve inches while the outside diameter D2 of the zone 32 is nineteen inches. In this particular case the zone 32 is formed as a cylinder having an inside radius of four inches from the waveguide 16 and an outside radius extending to within 2½ inches from the outer wall of the container 12. Within the 3½ inch radius of the zone 32, the contaminated resin is received at the top through the inlet valves 24 and 26, is cleaned within the uniform temperature of the zone 32, and the clean resins are metered through the outlet valves 28 and 30.

Further heat uniformity can be obtained in the zone 32 by moving the waveguide 16 relative to the container 12 and the zone 32. In a preferred embodiment, this relative movement is produced by oscillating the waveguide 16 axially up and down as shown by the arrow 38. The length of the oscillation will typically depend on the configuration of the slots within the waveguide. Generally slots, such as those designated by the reference numerals 40 and 42 are provided to disperse the energy from the waveguide 16. Typically these slots 40, 42 are vertically disposed and separated center-to-center by a distance of about one half or one wavelength. Groups of slots are also equally spaced around the circumference of the waveguide. Vertical movement of the waveguide 16 in a preferred embodiment is set for a total travel equivalent to the vertical distance end-to-end between the slots, such as the slots 40, 42. A motor 44 in combination with a ball screw 46 and nut 48 can be coupled to the waveguide 16 and operated to produce the axially oscillations.

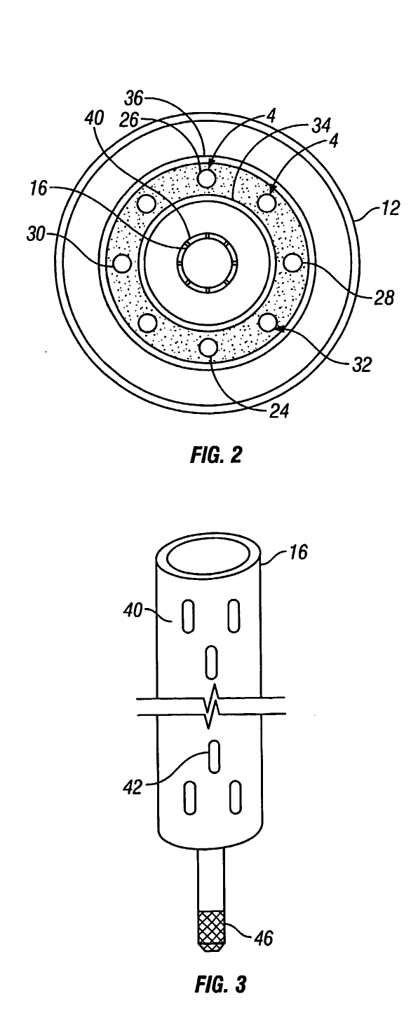

Further relative movement between the waveguide 16 and the container 12 can be provided by rotating the waveguide 16 relative to the zone 32. This can be a continuous rotation or an oscillating rotation caused by the motor 44. A top plan view of the system 10 is illustrated in FIG. 2 and taken along the lines 2-2 of FIG. 1. In this plan view, it can be seen that the inlet valves 24 and 26 can be diametrically opposed and angularly spaced by up to 90° from the outlet valves 28 and 30. The other two inlet valves (not shown) and exit valves (not shown) can be similarly spaced to facilitate a good flow and mixture of the contaminated resins within the zone 32.

A perspective view of the waveguide 16 is illustrated by itself in FIG. 3 and shows in greater detail the relationship of the slots 40 and 42 with respect to the waveguide 16 and associated ball screw 46.

From the foregoing discussion it will be apparent that more uniform heating can be achieved in two ways: 1) determining the radial zone having the greatest uniformity of heat disposition, and 2) moving the source of the microwaves relative to the load. In this second case, relative movement is required but that movement can occur with the waveguide 16 moving relative to a stationary container 12 or the container 12 moving relative to a stationary waveguide 16. In all cases, even heat distribution within the load is the ultimate goal. The specific dimensions and placement of parts may vary with the type of load, such as the type of resin or the type of material contaminating the load. These and other features and advantages will now be apparent to a person of ordinary skill in the art pertaining to this invention.

From the foregoing description of preferred embodiments it will be apparent that many of the advantages associated with the present invention can be achieved without departing from the spirit and scope of the invention. Therefore, it must be understood that the illustrated embodiments have been set forth only for the purposes of example and should not be taken as limiting the invention. Accordingly, one is cautioned not to limit the concept only to those embodiments disclosed, but rather to determine the scope of the invention only with reference to the following claims.

1. The system for removing contaminants adsorbed onto a resin, comprising:
a container adapted to receive the contaminated resin;
at least one waveguide having an axis and being adapted to introduce microwave energy into the contaminates in the container; and
means for moving one of the container and the waveguide relative to the other of the container and the waveguide to facilitate uniform heating of the contaminates.

2. The system recited in claim 1 wherein the moving means has properties for moving the waveguide relative to the container.

3. The system recited in claim 2 wherein the moving means has properties for oscillating the waveguide.

4. The system recited in claim 3 wherein the moving means oscillates the waveguide along the axis.

5. The system recited in claim 3 wherein the moving means oscillates the waveguide radially of the axis.

6. The system recited in claim 1 wherein the moving means rotates the waveguide on the axis.

7. The system recited in claim 1 wherein the container has an axis and the at least one waveguide is disposed coaxially with the container.

8. A system for removing contaminants adsorbed onto a resin, comprising:
a container having an outer wall and properties for receiving the contaminated resin;
a waveguide disposed in the container and having an inner wall, the waveguide having properties for introducing microwave energy into the container to heat the contaminants on the resin;
at least one zone wall disposed in the container between the inner wall and the outer wall, the zone wall defining a preferred zone within the container where optimum characteristics occur for heating the contaminants; and
the zone wall being formed of a low loss material having microwave transmission characteristics greater than that of a metal.

9. The system recited in claim 8 wherein the low loss material is a ceramic.

10. The system recited in claim 8 wherein the low loss material is fiberglass.

11. The system recited in claim 8 wherein the zone wall has the shape of a cylinder having a coaxial relationship with the inner wall of the waveguide.

12. The system recited in claim 8 wherein the at least one zone wall includes:
a first zone wall disposed between the outer wall of the container and the inner wall of the waveguide;
a second zone wall disposed between the first zone wall and the outer wall of the container; and
the first zone wall and the second zone wall defining the preferred zone between the inner wall of the waveguide and the outer wall of the container.

13. A method for removing contaminants adsorbed onto a resin, comprising the steps of:
providing a container to receive the contaminating resin;
positioning at least one waveguide within the container;
introducing microwave energy through the waveguide and into the container;
during the introducing step, heating the contaminants in the container to free the contaminants from the resin;
during the heating step moving one of the container and the waveguide relative to the other of the container and the waveguide to facilitate uniform heating of the contaminant; and
withdrawing the freed contaminants from the container.

14. The method recited in claim 13 wherein the moving step includes the step of moving the waveguide relative to the container.

15. The method recited in claim 14 wherein the waveguide has an axis and the moving step comprises the step of rotating the waveguide on its axis.

16. The method recited in claim 15 wherein the rotating step comprises the step of oscillating the waveguide.

17. The method recited in claim 14 wherein the waveguide has an axis and the moving step includes the step of axially moving the waveguide along its axis.

18. The method recited in claim 13 further comprising the steps of:
determining a preferred zone within the container where characteristics of the microwave heat are optimized for the contaminants and the resin;
moving the resin into the preferred zone; and
during the heating step, heating the contaminant in the preferred zone.

19. A method for removing contaminants adsorbed onto a resin, comprising the steps of:
providing a container having an axis and an outer wall;
positioning along the axis of the container a microwave waveguide having an inner wall;
defining a preferred zone in the container between the outer wall of the container and the inner wall of the waveguide, the preferred zone having optimum heating characteristics for heating the contaminant;
loading the contaminated resin into the preferred zone;
heating the contaminants in the preferred zone with the optimum heating characteristics to separate the contaminants from the resin; and
removing the separated contaminants from the preferred zone of the container.

20. A method recited in claim 19 further comprising the step of:
moving one of the container and the waveguide relative to the other of the container and the waveguide to facilitate uniform heating of the contaminants during the heating step.

21. The method recited in claim 20 wherein the moving step comprises the step of moving the waveguide relative to the container.

22. The method recited in claim 21 wherein the waveguide has an axis and the moving step includes the step of rotating the waveguide on its axis.

23. The method recited in claim 22 wherein the rotating step includes the step of oscillating the waveguide.

24. The method recited in claim 21 wherein the waveguide has an axis and the moving step includes the step of moving the waveguide along its axis.
